(19) United States
(12) Patent Application Publication
(10) Pub. No.: US 2008/0311876 A1
(43) Pub. Date: Dec. 18, 2008

(54) Signal Receiver for Wideband Wireless Communication

(75) Inventors: Dominicus M.W. Leenaerts, Riethoven (NL); Cornelis H. Van Berkel, Heeze (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/910,455

(22) PCT Filed: Mar. 16, 2006
(86) PCT No.: PCT/IB06/50827

§ 371 Date: Jun. 17, 2008

(30) Foreign Application Priority Data
Mar. 30, 2005 (EP) 05102497.4

(51) Int. Cl. H04B 1/26

(52) U.S. Cl. 455/313

(57) ABSTRACT

A signal receiver for use in a 60 GHz wireless area network, in which the received RF signal band (100) is converted to a plurality of intermediate frequency (IF) sub-bands (104) and then processing (LPF, AGC, ADC) in the analogue domain of the sub-bands (104) is performed in parallel. As a result, the design requirements of the analogue components are significantly relaxed and it is possible to perform gain control in respect of each sub-band (104), which improves the quality of the received signal.

The invention relates to a signal receiver for wideband wireless communication and, more particularly but not necessarily exclusively, to a signal receiver for use in a wireless local area network (WLAN) operating in the 60 GHz ISM band.

Ultra wideband (UWB) is an RF wireless technology, and provides a technique for performing radio communication and radio positioning which relies on sending a signal comprising ultra-short pulses occupying frequencies from zero to one or more GHz. These pulses represent from one to only a few cycles of an RF carrier wave.

International Patent application No. WO 2004/001998 describes an ultra-wideband (UWB) signal receiver comprising a filter bank for dividing a received RF signal into a plurality of frequency sub-bands. The sub-band signals are then digitized using a relatively low sample rate, following which each digitized sub-band signal is transformed into the frequency domain and the spectrum of the received signal is reconstructed.

In wireless communication applications, there is a need for increasingly higher data rates. However, for extremely high data rate point-to-point and point-to-multipoint applications, UWB often gives unsatisfactory results because of the trade-off between signal-to-noise ratio and bandwidth. The 60 GHz band (roughly 59-63 GHz), an unlicensed frequency band, has thus been investigated as a potential band for wireless high data rate transmission, due to the wide band (up to 4 GHz) which is available.

In general, the use of digital signal processing techniques to implement at least the baseband processing of a wireless receiver is known to provide benefits such as increased versatility and decreased cost, provided the frequency of the signals to be digitized is not too high. Thus, relatively low speed analog-to-digital converters can be used in the receiver of WO 2004/001998. In other systems, a received RF signal is mixed down to a low IF (intermediate frequency) before digitization, because digitization at the original high frequency requires an unacceptably high speed analog-to-digital converter (ADC). The term intermediate frequency (IF) used herein refers to a frequency to which a carrier frequency is shifted as an intermediate step in signal (transmission or) reception; and, if a heterodyne signal is down-converted, then:

f_{IF}=f_{RF}−f_{LO}

where f_{IF} is the intermediate frequency, f_{RF} is the radio frequency and f_{LO} is the local oscillator frequency. Thus, if the bandwidth is 4 GHz and a zero-IF architecture is adopted, a 2 GHz bandwidth is generated at the positive frequency side, which is almost RF in itself, and therefore makes IF filtering on silicon difficult.

It is therefore an object of the present invention to provide a signal receiver for receiving a wideband signal to achieve relatively higher data rates, wherein processing in the analog domain is reduced in complexity.

In accordance with a first aspect of the present invention, there is provided a signal receiver comprising means for receiving a wideband radio frequency signal having a first carrier frequency, means for generating a plurality of intermediate frequency (IF) sub-bands, each sub-band being representative of a portion of the received radio frequency signal band and said plurality of sub-bands together defining an intermediate frequency signal band having a second carrier frequency lower than said first carrier frequency and being representative of said received radio frequency signal band, the receiver further comprising intermediate frequency (IF) processing means for performing parallel processing of each of said sub-bands in the analog domain and then performing analog-to-digital conversion of said processed sub-bands, and means for combining the resultant digital signals for subsequent further processing.

In accordance with a second aspect of the present invention, there is provided a signal receiver comprising means for receiving a wideband radio frequency signal having a carrier frequency, means for sub-sampling said received radio frequency signal band at a frequency lower than said carrier frequency so as to generate a plurality of discrete sub-bands, each sub-band being representative of a portion of the received radio frequency signal band, the receiver further comprising intermediate frequency (IF) processing means for performing parallel processing of each of said sub-bands in the analog domain and then performing analog-to-digital conversion of said processed sub-bands, and means for combining the resultant digital signals for subsequent further processing.

The present invention extends to a wireless area network having at least one transmitter for transmitting a wideband radio frequency signal and at least one signal receiver as defined above.

As a result of the signal receiver of the present invention, lower complexity in respect of the processing in the analog domain is achieved, particularly in respect of, for example, the respective gain controllers, IF filters and analog-to-digital converters. Furthermore, as a result of the present invention, it is possible to perform automic gain control in respect of each sub-band, thereby improving the quality of the resultant signal.

In one embodiment of the first aspect of the present invention, the means for generating the plurality of intermediate frequency sub-bands may be arranged and configured to shift the carrier frequency of the received radio frequency signal to a lower intermediate frequency and then perform parallel filtering of the resultant signal band to divide the signal band into a plurality of intermediate frequency sub-bands.

In this case, a plurality of digital filtering means may be provided, each digital filtering means having substantially the same band pass characteristic with respectively varying center frequencies corresponding to respective sub-carrier frequencies of the intermediate frequency sub-bands.

In an alternative embodiment of the first aspect of the present invention, the means for generating the plurality if intermediate frequency sub-bands may be arranged and configured to nominally divide the received radio frequency signal band into a plurality of sub-bands, each having a sub-carrier frequency, and then to shift the sub-carrier frequency of each of the sub-bands to a lower intermediate frequency.

In this case, a radio frequency synthesizer, having as input a plurality of local oscillator signals of the respective sub-carrier frequencies, is provided to generate the respective plurality of intermediate frequency sub-bands.

In either case, the power spectral density of the intermediate frequency signal band is preferably centered around the second carrier frequency, which is preferably substantially zero. The received radio frequency signal band may be in the 60 GHz (−59-63 GHz) spectrum.

In one embodiment of the second aspect of the present invention, a dedicated band pass filter may be provided in respect of the sub-bands adjacent the carrier frequency.

In all cases, the parallel processing of the sub-bands in the analog domain comprises at least low pass filtering and/or automatic gain control in respect thereof.

These and other aspects of the present invention will be apparent from, and elucidated with reference to, the embodiments described herein.

Embodiments of the present invention will now be described by way of examples only and with reference to the accompanying drawings, in which:

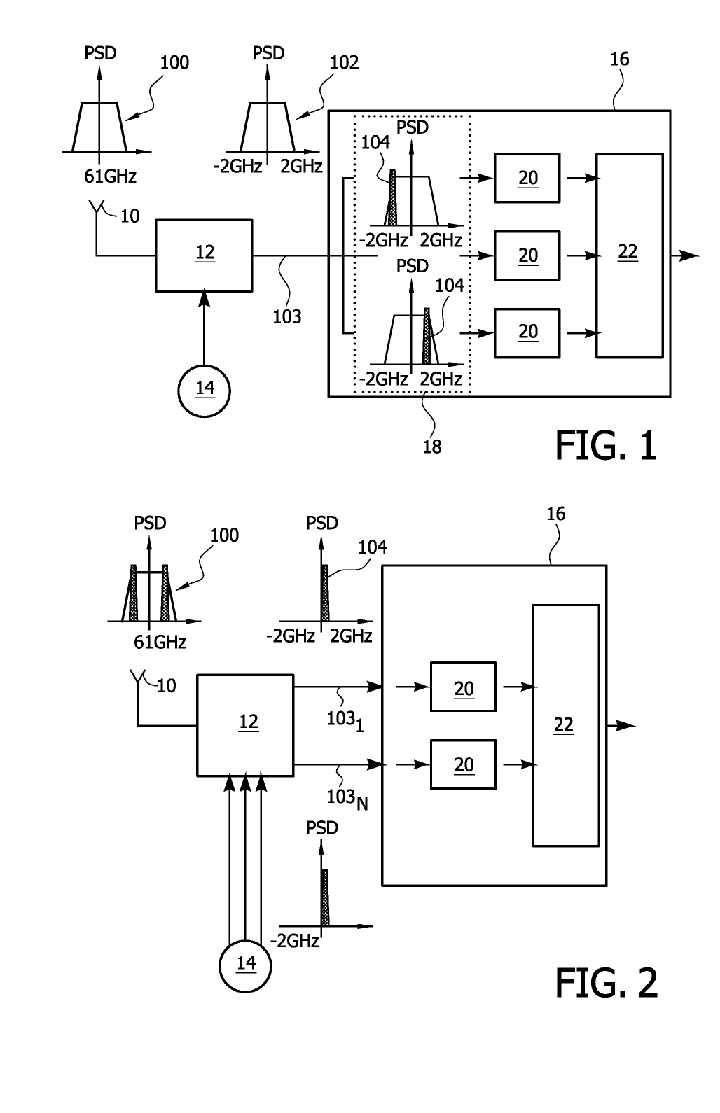

FIG. 1 is a schematic diagram illustrating the principal components of a signal receiver according to a first exemplary embodiment of the first aspect of the present invention;

FIG. 2 is a schematic diagram illustrating the principal components of a signal receiver according to a second exemplary embodiment of the first aspect of the present invention; and

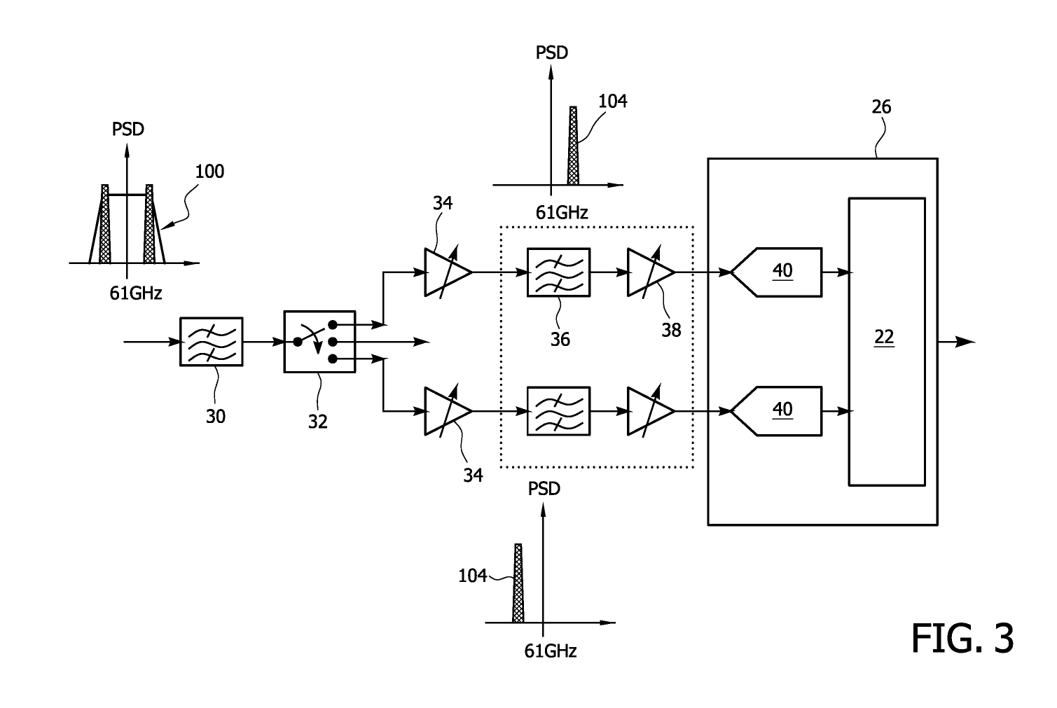

FIG. 3 is a schematic diagram illustrating the principal components of a signal receiver according to an exemplary embodiment of the second aspect of the present invention.

Thus, the present invention provides a signal receiver which receives a wideband radio frequency signal and divides it into sub-bands, before performing parallel processing and subsequent analog-to-digital conversion in respect of each sub-band in the analog domain. The resultant signals are then combined to reconstruct the signal for further processing in the digital domain.

Referring to FIG. 1 of the drawings, in a first exemplary embodiment, a radio frequency signal 100 in the 60 GHz band is received by an antenna 10 and passed to a radio receiver 12. As shown, the power spectral density (PSD) is centered around a carrier frequency of 61 GHz. The complete received radio frequency signal band 100 of bandwidth 4 GHz is down-converted by a radio frequency (RF) synthesizer in the radio receiver 12 to an intermediate frequency signal band 102. The RF synthesizer receives a local oscillator signal for this purpose from a voltage controlled oscillator 14, which is arranged and configured to generate a local oscillator signal at the PSD/carrier frequency of 61 GHz. A zero-IF architecture is employed which results in an intermediate frequency signal band 102 having a PSD/carrier frequency of zero, with 2 GHz of the original bandwidth in the positive frequency domain and 2 GHz in the negative frequency domain.

The resultant intermediate frequency signal band 102 is then passed to the input 103 of an IF processing module 16. The IF processing module 16 comprises a bank 18 of digital filters for performing parallel digital filtering of the incoming IF signal band, each digital filter having substantially the same band pass characteristic but different respective center frequencies, so that the IF signal band 102 is effectively divided or ‘chopped’ into a plurality of respective IF sub-bands 104. This ‘chopping’ can be performed, for example, in the form of arbitrary ‘bins’ or based on OFDM sub-carrier frequencies (corresponding to respective center frequencies of the digital filters). Together, the plurality of sub-bands 104 are representative of the IF signal band 102, with the PSD frequency of zero being maintained.

Each sub-band 104 is then passed to a respective processing module 20 such that parallel processing of the IF sub-bands 104 can be performed in the analogue domain. Each processing module 20 comprises an active analog filter for selecting a channel of interest. Active filters suffer from high input noise level, which can easily dominate the receiver noise figure. Thus, a variable gain amplifier (VGA) embedded in an automatic gain control (AGC) loop is also provided in each processing module 20 to amplify each sub-band signal sufficiently to overcome filter noise. The processed signal is then passed to a respective analog-to-digital converter (ADC), also provided in the processing module 20. In the digital domain, the information from each of the sub-bands, which information was spread throughout the original signal band, is ‘assembled’ or combined for further processing at module 22, which gathers all of the information and processes it to extract the bits.

Thus, because each of the IF sub-bands are processed in parallel in the analogue domain, the design requirements for components, such as the AGC loop and ADC, are significantly relaxed relative to the situation whereby the complete signal band is treated unitarily. Of course, the IF filtering component is a little more complex because it effectively involves a bank of filters having the same band pass characteristic but changing center frequencies, as described above.

Referring to FIG. 2 of the drawings, an alternative exemplary embodiment of the first aspect of the present invention is illustrated schematically, in which like reference numerals are used to denote similar elements to those of the arrangement of FIG. 1. In the arrangement of FIG. 2, the original radio frequency received signal 100 is down-converted into IF sub-bands 104, for example, bins or based on their OFDM sub-carriers, and each sub-band 104 is passed to the IF processing module 16. In this case, of course, the IF processing module 16 has N inputs 103₁ . . . 103_{N}, compared with just one in the arrangement of FIG. 1.

As before, the IF processing module 16 comprises a respective processing module 20 to which respective sub-bands 104 are passed, such that parallel processing of the IF sub-bands 104 can be performed in the analogue domain. Each processing module 20 comprises an active analog filter for selecting a channel of interest. Active filters suffer from high input noise level, which can easily dominate the receiver noise figure. Thus, a variable gain amplifier (VGA) embedded in an automatic gain control (AGC) loop is also provided in each processing module 20 to amplify each sub-band signal sufficiently to overcome filter noise. The processed signal is then passed to a respective analog-to-digital converter (ADC), also provided in the processing module 20. In the digital domain, the information from each of the sub-bands, which information was spread throughout the original signal band, is ‘assembled’ or combined for further processing at module 22, which gathers all of the information and processes it to extract the bits.

Again, because each of the IF sub-bands are processed in parallel in the analogue domain, the design requirements for analogue processing components such as the AGC loop and ADC are relaxed, as is the filtering component, since fixed low pass filtering is employed. However, the RF synthesizer in the radio receiver 12 is more complex than that of the arrangement of FIG. 1 because more oscillator signals are required to be generated at once (i.e. in respect of each IF sub-band to be generated) in accordance with a multi-tone concept similar to that of UWB systems.

Referring to FIG. 3 of the drawings, in an exemplary embodiment of the second aspect of the present invention which employs sub-sampling, the received RF signal 100 is passed via a band pass filter 30 to a sampler 32 which samples the received signal 100 with a frequency lower than the RF carrier frequency (which is 61 GHz in this case). Each sampled signal is then passed to a respective low noise amplifier (LNA) 34, a band pass filter 36 and an RF variable gain amplifier (VGA) 38 and then to a respective analog-to-digital converter (ADC) 40 in an IF processing module 16. As before, in the digital domain, the information from each of the sub-bands, which information was spread throughout the original signal band, is ‘assembled’ or combined for further processing at module 22, which gathers all of the information and processes it to extract the bits.

The band pass filters 36 are dedicated band pass filters at the bins around the RF carrier frequency (61 Hz) but the AGC 38 and ADC are low frequency components. IF processing is again performed in parallel.

Thus, in all of the above exemplary embodiments of the present invention, there is parallel processing of sub-bands of the received signal band in the analogue (IF) domain. The main advantages of this include lower complexity in the analogue domain for components such as the analog-to-digital converters, gain controllers and IF filters, and also the ability to adjust the gain per “bin” or “sub-band”, thereby improving the quality of the received signal.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A signal receiver comprising means for receiving a wideband radio frequency signal having a first carrier frequency, means for generating a plurality of intermediate frequency sub-bands, each sub-band being representative of a portion of the received radio frequency signal band and said plurality of sub-bands together defining an intermediate frequency signal band having a second carrier frequency lower than said first carrier frequency and being representative of said received radio frequency signal band, the receiver further comprising intermediate frequency processing means for performing parallel processing of each of said sub-bands in the analog domain and then performing analog-to-digital conversion of said processed sub-bands and means for combining the resultant digital signals for subsequent further processing.

2. A signal receiver according to claim 1, wherein the means for generating the plurality of intermediate frequency sub-bands is arranged and configured to shift the carrier frequency of the received radio frequency signal to a lower intermediate frequency and then perform parallel filtering of the resultant signal band to divide the signal band into a plurality of intermediate frequency sub-bands.

3. A signal receiver according to claim 2, wherein digital filtering means are provided, each digital filtering means having substantially the same band pass characteristic with respectively varying center frequencies corresponding to respective sub-carrier frequencies of the intermediate frequency sub-bands.

4. A signal receiver according to claim 1, wherein the means for generating the plurality if intermediate frequency sub-bands is arranged and configured to nominally divide the received radio frequency signal band into a plurality of sub-bands, each having a sub-carrier frequency, and then to shift the sub-carrier frequency of each of the sub-bands to a lower intermediate frequency.

5. A signal receiver according to claim 4, wherein a radio frequency synthesizer, having as input a plurality of local oscillator signals of said respective sub-carrier frequencies, is provided to generate the respective plurality of intermediate frequency sub-bands.

6. A signal receiver according to claim 1, wherein the second carrier frequency in respect of the intermediate frequency signal band is substantially zero.

7. A signal receiver according to claim 1, wherein the received radio frequency signal band is in the 60 GHz spectrum.

8. A signal receiver comprising means for receiving a wideband radio frequency signal having a carrier frequency, means for sub-sampling said received radio frequency signal band at a frequency lower than said carrier frequency so as to generate a plurality of discrete sub-bands, each sub-band being representative of a portion of the received radio frequency signal band the receiver further comprising intermediate frequency (IF) processing means for performing parallel processing of each of said sub-bands in the analog domain and then performing analog-to-digital conversion of said processed sub-bands-, and means for combining the resultant digital signals for subsequent further processing.

9. A signal receiver according to claim 8, wherein a dedicated band pass filter is provided in respect of the sub-bands adjacent the carrier frequency.

10. A signal receiver according to claim 1, wherein parallel processing of the sub-bands in the analog domain comprises at least low pass filtering and/or automatic gain control in respect thereof.

11. A wireless area network having at least one transmitter for transmitting a wideband radio frequency signal and at least one signal receiver according to claim 1.
